(19) United States
(12) Patent Application Publication
(10) Pub. No.: US 2019/0155598 A1
(43) Pub. Date: May 23, 2019

(54) TECHNIQUES FOR UPDATING A FILE USING A MULTI-VERSION PATCH FILE

(71) Applicant: Apple Inc., Cupertino, CA (US)

(72) Inventors: Eric BAINVILLE, Sunnyvale, CA (US); Ali SAZEGARI, Cupertino, CA (US)

(21) Appl. No.: 15/823,376

(22) Filed: Nov. 27, 2017

Related U.S. Application Data
(60) Provisional application No. 62/588,286, filed on Nov. 17, 2017.

(51) Int. Cl. G06F 9/44; H04L 29/08

(52) U.S. Cl. CPC G06F 8/68; H04L 67/2852

(57) ABSTRACT

The embodiments set forth a technique that generates a multi-version patch file at a server computing device. The technique includes, modifying a first file to produce a plurality of versions associated with the first file, in which the plurality of versions includes: (i) a latest version associated with the first file, and (ii) at least two previous versions relative to the latest version. The technique also includes identifying a difference between the latest version and the two previous versions to produce first and second delta versions of the first file. Furthermore, the technique includes generating the multi-version patch file for installation by a client computing device, in which the multi-version patch file (i) includes the first and second delta versions, and (ii) causes a second file stored on the client computing device to be updated to the latest version using at least one of the first and second delta versions.

### CROSS-REFERENCE TO RELATED APPLICATIONS

The present application claims the benefit of U.S. Provisional Application No. 62/588,286, entitled “TECHNIQUES FOR UPDATING A FILE USING A MULTI-VERSION PATCH FILE,” filed Nov. 17, 2017, the content of which is incorporated herein by reference in its entirety for all purposes.

### FIELD OF INVENTION

The described embodiments relate generally to techniques for generating a patch file. More particularly, the present embodiments relate to techniques that generate a multi-version patch file that can be used to update a file on a client computing device.

### BACKGROUND

Many modern day applications and operating systems occasionally require program code modifications to correct a defect found in those applications/operating systems. Defects can include, for example, unintended behaviors known as “bugs,” security breaches that can potentially result in the loss of data privacy maintained by the application/operating system, corrupted data, and so on. In some instances, an application or operating system can require an occasional update in order to enable a user to utilize new features associated with a newer version of the application/operating system. In response, developers and/or distributors of a particular application/operating system often release one or more software “patches,” included in a patch file, that are intended to specifically address one or more of the aforementioned defects or provide the user with a version of the application/operating system that includes new features. The patch file can be communicated, to one or more client computing devices, as an over-the-air (“OTA”) update file which is distributed from a server computing device.

In most circumstances, the patches are very specific and require only a slight modification of program code associated with a particular file. The modification of the program code in this manner results in the creation of a modified file. In this fashion, the modified file becomes a latest version of the file in which all other existing versions of the file are superseded, thereby making each superseded version a prior version of the file. Despite requiring only slight program code modifications to produce the latest version of the file, the latest version of the file nevertheless still needs to be quickly distributed to all client computing devices that have the application/operating system installed in order to (1) minimize any potential damage caused by the one or more defects, or (2) enable the client computing devices to have quicker access to newly added features provided by the latest version of the file.

However, when distributing a patch file to the client computing devices, conventional solutions fail to consider a number of issues. One issue is that several different prior versions of a file can be already installed on different client computing devices. To address this issue, conventional solutions create several different patch files that each target different prior versions of the file. These separate patch files each include a single update file intended for a specific prior version of the file. Accordingly, the creation of separate patch files in this manner results in wasted computational resources used to generate each update file as well as unnecessary delays in getting patch files to client computing devices.

Another issue is that conventional solutions require a “full replacement” file update in which a file is completely replaced with a new file to fix the one or more defects. As a result, a patch file including the full replacement file unnecessarily increases the size of the patch file, which can delay the delivery of the patch file to the client computing devices. This scenario is especially problematic when weak data transmission speeds or poor network connectivity are involved. For instance, the increased size of the patch file affects how quickly distributors of the patch file can transmit the patch file over a network as well as the ability of each client computing device to receive the patch file in a timely fashion.

In some scenarios, conventional solutions try to include several different update files within a patch file in which each update file needs to be installed, in combination, in order to fix the one or more defects. However, this strategy suffers the same issues discussed above in which the patch file is unnecessarily increased in size and also requires the client computing device to spend more time installing multiple files in order to receive a latest version of a particular file. Another effect of increasing a patch file size is that larger amounts of free memory storage space are needed at the client computing device in order to install the patch file. Given the general unpredictability of when a patch file release occurs, any patch file size increases can directly impact when a client computing device can install the patch file. For instance, if the client computing device does not have sufficient free memory storage space to install a newly released patch file, the client computing device will be forced to delay installation of the patch file until the sufficient storage space is created. As a result, a customer can have a negative experience with an application/operating system in need of the patch file until the file update installation occurs at the client computing device. Yet another issue is that several different types of client computing devices, with different hardware/software profiles, can each execute a same application/operating system that requires the same file update to address one or more defects. In response, conventional solutions employ the same technique as described above and create separate patch files that each include a single update file that is intended for use by a specific type of client computing device. Accordingly the same computational resource and delivery concerns remain and are left unaddressed by conventional solutions.

In addition to the deficiencies mentioned above, conventional solutions also fail to provide any measures that minimize the occurrence of installation failures when a client computing device attempts to install a patch file. For instance, during a patch file installation, the client computing device may encounter interruptions that include a sudden loss of power, a sudden lack of sufficient memory space, or similar interruptions that may require a reboot of the client computing device in order to successfully complete the patch file installation process. Notably, such interruptions to the patch file installation process can result in an unstable build of the latest version of the file, regardless of whether a client computing device uses an “out-of-place” file-write system or an “in-place” file-write system.

For instance, during a patch file installation on an “out-of-place” file-write system, the current version of the file installed on the client computing device is loaded from disk (e.g., non-volatile memory) into memory (e.g., volatile memory) and used to build the contents of the latest version of the file. However, when an interruption to the patch file installation occurs, the current version of the file is no longer present on the disk and, thus, no longer available for use in the patch file installation process after the interruption. Also, during a patch file installation on an “in-place” file-write system, the current version of the file installed on the client computing device is modified on the disk through a sequence of reads and writes in order to build the contents of the latest version of the file. However, when an interruption to the patch file installation process occurs in this instance, the current version of the file can be placed in an invalid, corrupted, or otherwise unrecognizable state. In these situations, the ability to use the current version of the file in the patch file installation process, after the interruption, is greatly compromised.

Accordingly, as a result of the issues discussed above, developers and/or distributors of a particular application/operating system are in dire need of a solution that can both minimize computational resource costs while also quickly and efficiently deliver patch files to a variety of different client computing devices so that users of the application/operating system can use an up-to-date version of the application/operating system that includes minimal defects. Furthermore, developers and/or distributors of a particular application/operating system are also in need of a solution that can (1) minimize the occurrence of patch file installation errors and (2) perform actions that can remedy a potentially unstable build of a latest version of the file in the event that an interruption occurs during a patch file installation.

### SUMMARY

Accordingly, the representative embodiments set forth herein disclose techniques that minimize the amount of time spent, by a server computing device, creating patch files for each available version of a particular file, whenever the file is modified. Additionally, the representative embodiments set forth herein disclose techniques that use cache memory available at the server computing device to store code delta calculations already performed in order to eliminate the need to perform repetitive calculations when creating a patch file.

One embodiment sets forth a method for generating a multi-version patch file. In particular, the method includes, at a server computing device, modifying a first file to produce a plurality of versions associated with the first file, in which the plurality of versions includes: (i) a latest version associated with the first file, and (ii) at least two previous versions relative to the latest version. Next, the method involves identifying a difference between the latest version and the at least two previous versions to produce first and second delta versions of the first file. Finally, the method involves generating the multi-version patch file for installation by a client computing device, in which the multi-version patch file (i) includes the first and second delta versions, and (ii) causes a second file, that corresponds to the first file and stored on the client computing device, to be updated to the latest version using at least one of the first and second delta versions.

One embodiment sets forth a method for updating a file at a client computing device using a multi-version patch file. In particular, the method includes, at the client computing device, selecting a first delta file, from the multi-version patch file, to update a previous version of the file currently installed on the client computing device to a latest version of the file, in which the multi-version patch file includes a plurality of different delta files that each correspond to different previous versions of the file. Next, the method involves generating a copy of the previous version at the client computing device. Next, the method involves producing the latest version using the previous version. Finally, the method involves switching to the copy to produce the latest version based at least in part on a first interruption being detected at the client computing device.

Other embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of a system that can be configured to perform the various techniques described herein, according to some embodiments.

FIGS. 2A-2E illustrate exemplary procedures that are used to generate a multi-version patch file for distribution to different client computing devices, according to some embodiments.

FIG. 3 illustrates how a multi-version patch file generated by a server computing device can be distributed among several different client computing devices, according to some embodiments.

FIGS. 4A-4E illustrate how a multi-version patch file generated by a server computing device can be used to reduce the chances of a patch file installation failure occurring on a client computing device, according to some embodiments.

FIG. 5 illustrates exemplary delta code caching procedures performed during the creation of a multi-version patch file, according to some embodiments.

FIG. 6 illustrates a method for generating a multi-version patch file at a server computing device, according to some embodiments.

FIGS. 7A-7B illustrate a method for reducing the chances of a patch file installation failure occurring on a client computing device, according to some embodiments.

FIG. 8 illustrates a detailed view of a computing device that can be used to implement the various components described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

It should be noted that the embodiments described herein discuss patch files/file updates that are performed for applications, however the embodiments described herein are not limited as such and can be used by other software entities including, for example, operating systems. As previously described herein, conventional solutions for both the generating and distributing patch files result in wasted computational resources as well as unnecessary delays in getting update files to client computing devices. To cure this deficiency, the embodiments set forth herein provide various techniques that minimize the amount of time spent creating patch files for each available version of a particular file, whenever the file is modified. Additionally, using cache memory available on a server computing device, the embodiments set forth herein also eliminate the need to perform repetitive calculations to create patch files for each different version, in existence, of the file. In this fashion, different types of client computing devices that require the same file update can quickly and efficiently receive a patch file in a manner that allows each device to execute an application with minimal defects.

As will be described in greater detail, the described embodiments calculate a code delta for each previous version of a newly modified file by comparing the differences between the newly modified file (i.e., the latest version of the file) and each of at least two different previous versions of the file. In this manner, each code delta can be used to update a particular prior version of a file to a latest version of the file, without the need to install any intermediate files or additional code deltas. Each code delta can then be compressed in a manner that enables the server computing device to deliver a patch file that includes a number of different code deltas to be distributed to several different client computing devices more quickly. In this fashion, each client computing device, in receipt of the distributed patch file, can use just a single code delta to install the latest version of a given file.

Additionally, the described embodiments also perform delta code caching procedures that eliminate the need to re-calculate a code delta each time a file is modified. As will be described herein, prior to performing the code delta calculations described above, the described embodiments initially determine whether a code delta has already been calculated to account for differences between a particular prior version of a file and a latest version of the file. If a calculation has already been performed, the described embodiments then bypass the performance of code delta calculations and, instead, quickly retrieve the previously calculated code delta from local cache memory. As will also be described in greater detail, the storage of code deltas in this fashion also enables the described embodiments to re-distribute previously calculated code deltas to different types of client computing devices using the same patch file. For instance, a smartphone, such as Apple Inc.'s iPhone® and a tablet computing device, such as Apple Inc.'s iPad® tablet computing device, can both use the same patch file and appropriate code delta included therein to install the same latest version of a particular file.

Also, as will be described herein, the described embodiments can use a special script that (1) detects which version of a particular file is currently installed on a client computing device and (2) direct the client computing device to follow a specific set of instructions that enable the client computing device to install the latest version of the file. In this fashion, the client computing device can be directed to install an appropriate code delta, despite the patch file including several different code deltas. As will be readily apparent by the exemplary embodiments set forth herein, the described embodiments can perform an N:1 combination update in which several different versions of a newly modified file can be updated using a single patch file, rather than a standard 1:1 file update that is performed using conventional approaches.

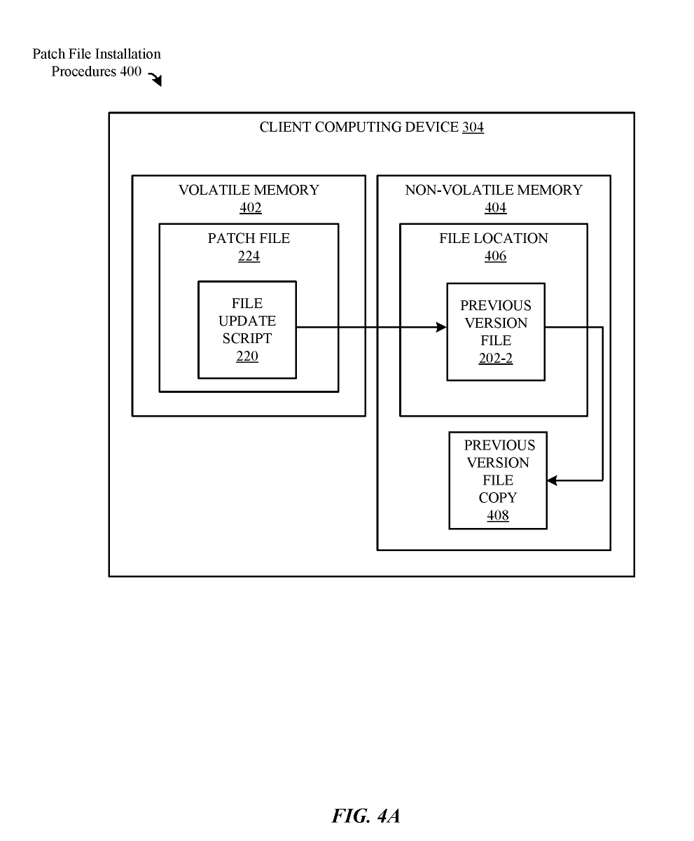

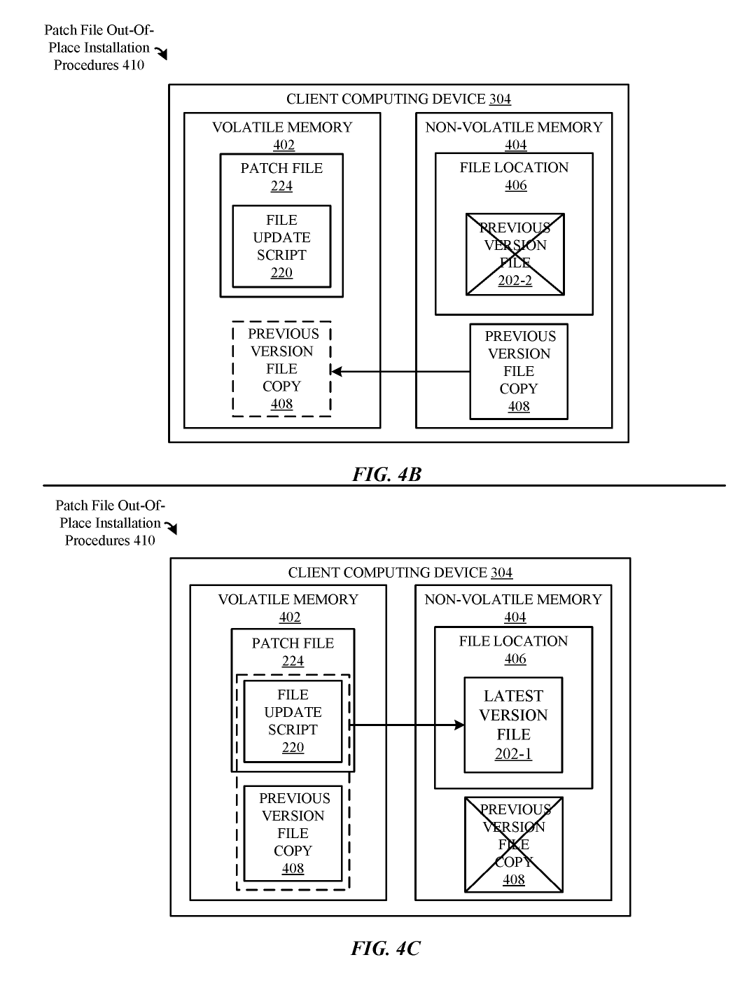

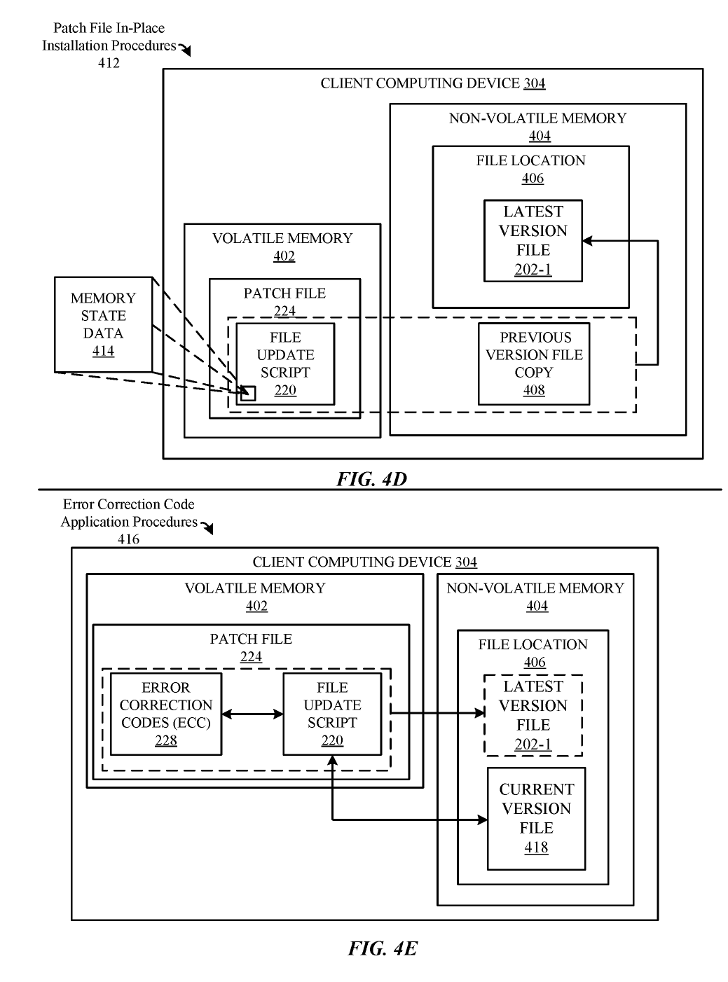

Furthermore, as will be described in greater detail in FIGS. 4A-4D, the described embodiments can increase the chances of successfully installing a patch file on a client computing device by, in certain circumstances, advantageously accessing a copy of a previous version of a file to be updated in order to build the latest version of the file. Also, as will be described in greater detail in FIG. 4E, the described embodiments can also use error correction codes (“ECCs”) in order to significantly reduce the chances of building an unstable form of the latest version of the file.

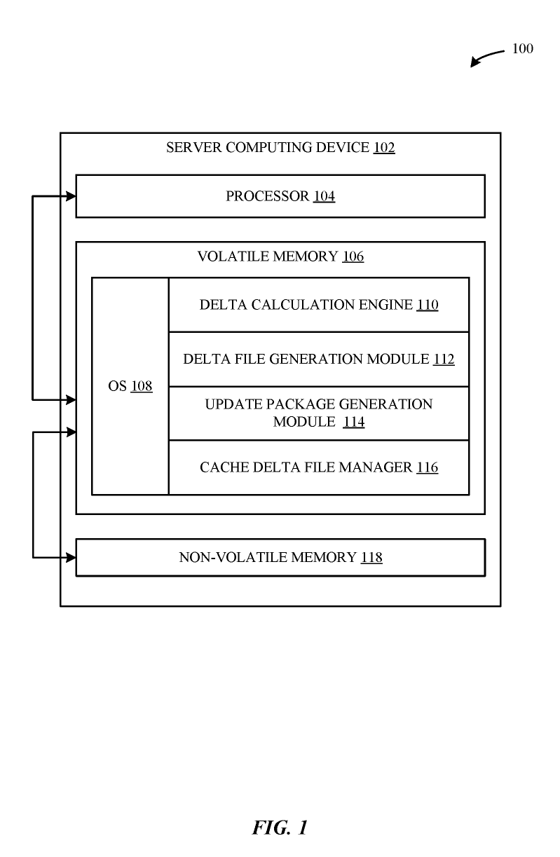

A more detailed description of the various techniques described herein, and the manner in which they can be implemented, is provided below in conjunction with FIGS. 1, 2A-2E, 3, 4A-4E, 5, 6, 7A-7B, and 8.

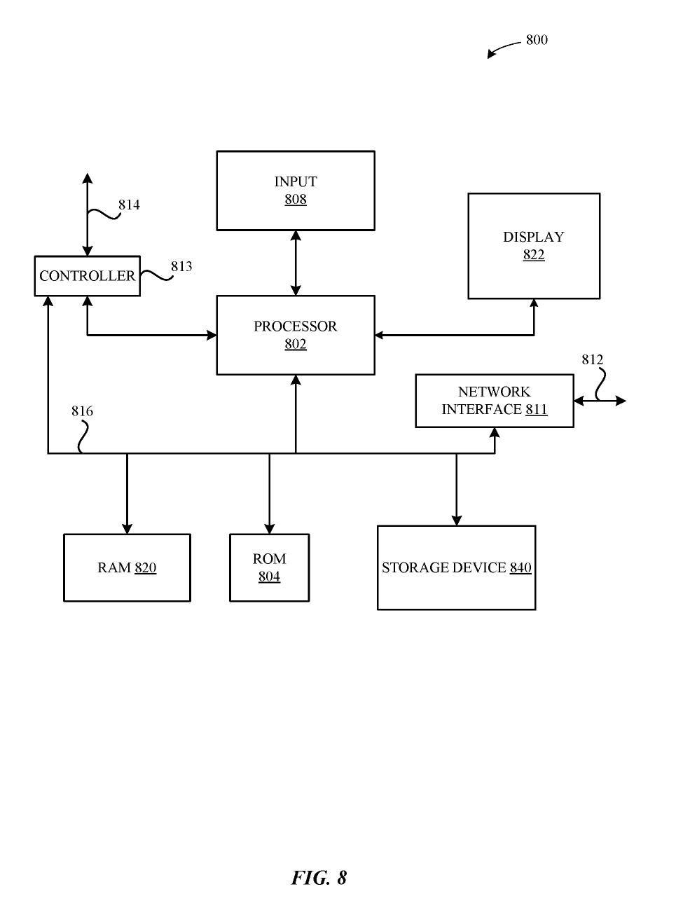

FIG. 1 illustrates a high-level overview 100 of a server computing device 102 that can be configured to perform the various techniques described herein. According to some embodiments, the server computing device 102 can be utilized by developer and/or distributor of a particular application that occasionally requires a patch file to be created. As shown in FIG. 1, the server computing device 102 can include a processor 104, a volatile memory 106 (e.g., a Random-Access Memory (“RAM”)), and a non-volatile memory 118 (e.g., a storage device). It is noted that a more detailed breakdown of example hardware components that can be included in the computing device 800 illustrated in FIG. 8, and that these components are omitted from the illustration of FIG. 1 merely for simplification purposes. For example, the server computing device 102 can include additional non-volatile memories (e.g., solid state drives, hard drives, etc.), other processors (e.g., a multi-core central processing unit (“CPU”)), and the like. With reference now to the server computing device 102, according to some embodiments, an operating system (“OS”) 108 can be loaded at the volatile memory 106, where the OS 108 can be enabled to execute a variety of applications that enable the various techniques described herein to be implemented. As described in greater detail herein, such applications can include a delta calculation engine 110, a delta file generation module 112, an update package generation module 114, and a cache delta file manager 116.

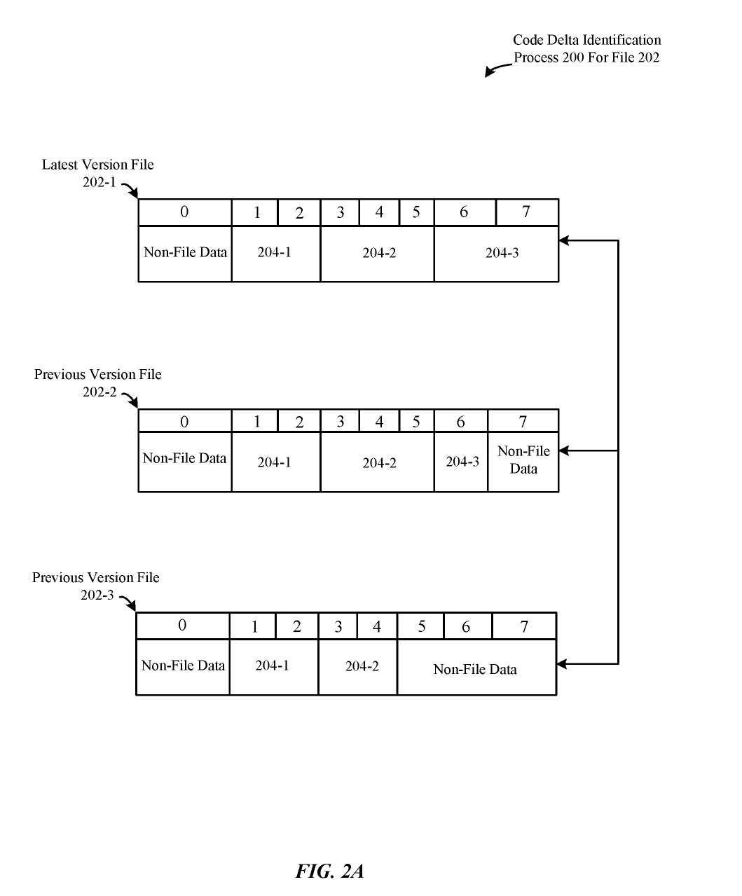

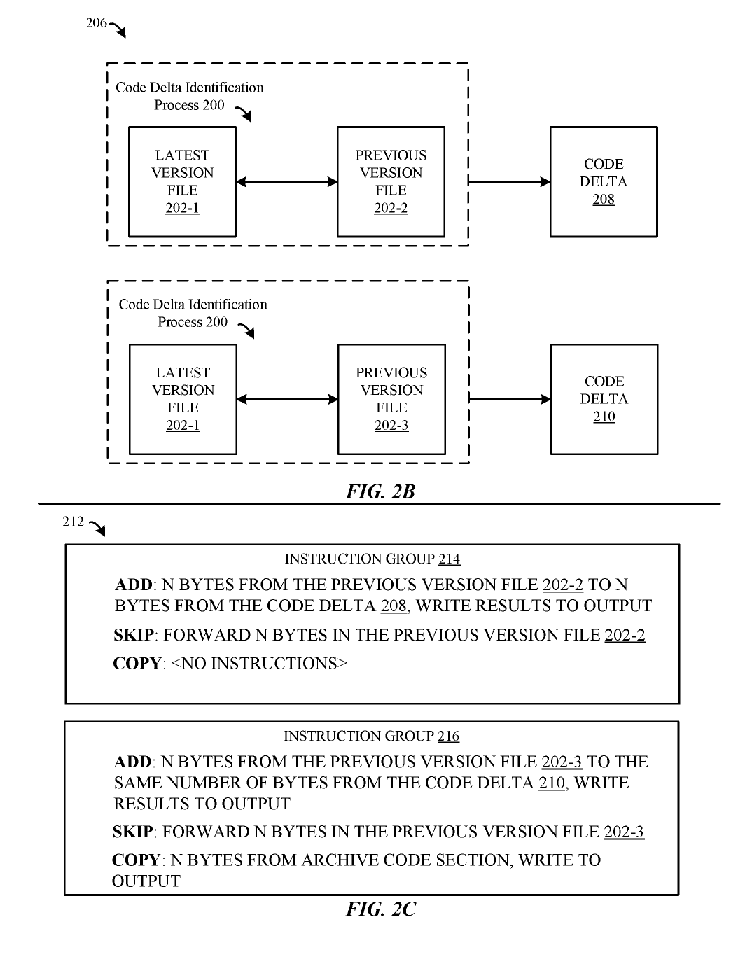

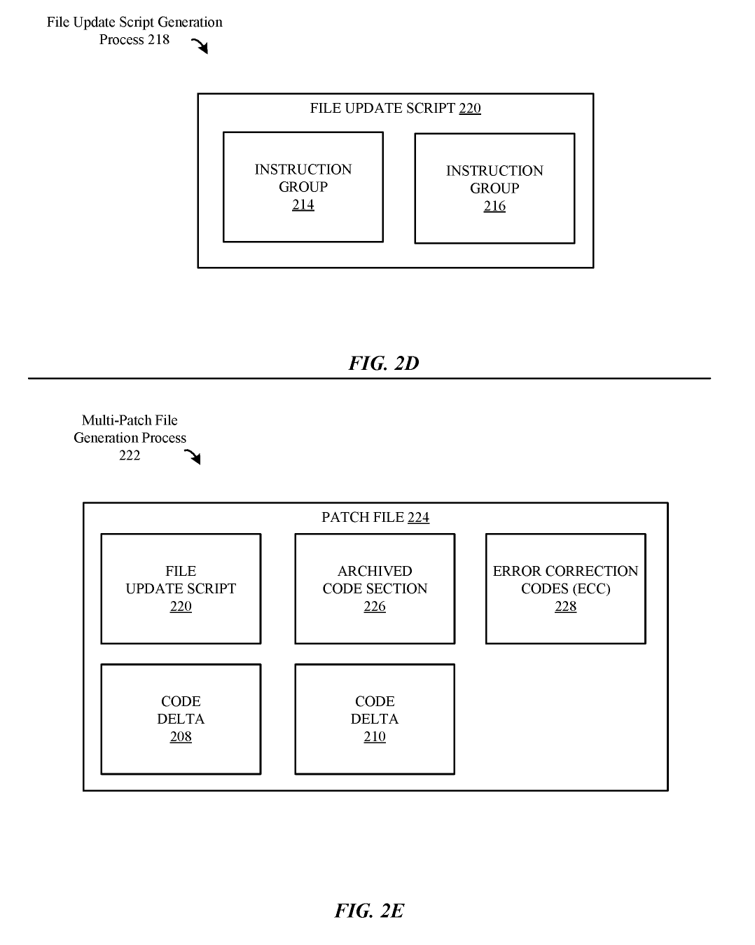

According to some embodiments, the delta calculation engine 110 includes the functionality to identify file differences (e.g., using binary file comparison procedures or similar techniques) between at least two or more different versions of a particular file associated with an application. As will be described in greater detail herein in FIG. 2A, the differences in program code, identified by the delta calculation engine 110, can be minimal differences that do not require a “full replacement” file update for the file. It should be appreciated that the term “patch” or “patch file” is not meant to be limiting and can include, for example, any file update that is intended to address a particular defect and/or improve the functionality of an application already installed at one or more computing devices.

As will be described in greater detail, according to some embodiments, the delta calculation engine 110 can perform procedures to determine file differences upon receipt of two or more versions of a file as input. In some scenarios, the differences between versions of the file can be very minor in instances where the two or more versions are released in sequential order (i.e., a “10.1” version, a “10.2” version, a “10.3” version, and so on). In this fashion, each version can use code deltas produced by the described embodiments in order to be updated to a latest version of the file. Accordingly, the resultant data produced by the delta calculation engine 110 can be used by the delta file generation module 112 to produce compressed binary deltas, referred to hereinafter as “code deltas,” which will be discussed now.

According to some embodiments, the delta file generation module 112 includes the functionality to compress one or more files code deltas using a compressor (not depicted). In this fashion, the delta file generation module 112 can (1) receive resultant data produced by the delta calculation engine 110 that is based on identified file differences between two or more versions of a same file, and (2) generate a corresponding compressed version of the resultant data in the form of a code delta that represents those differences. As will be described in greater detail in FIGS. 2C-2D, the delta file generation module 112 can also create multiple instruction groups for inclusion within a file update script that can be used by a client computing device to perform a file update. For instance, as will be described in greater detail, an instruction group created by the delta file generation module 112 can include instructions that enable a client computing device to select an appropriate code delta among a number of different code delta included within a particular patch file. Patch files created by the described embodiments are produced by the update package generation module 114, which will now be discussed.

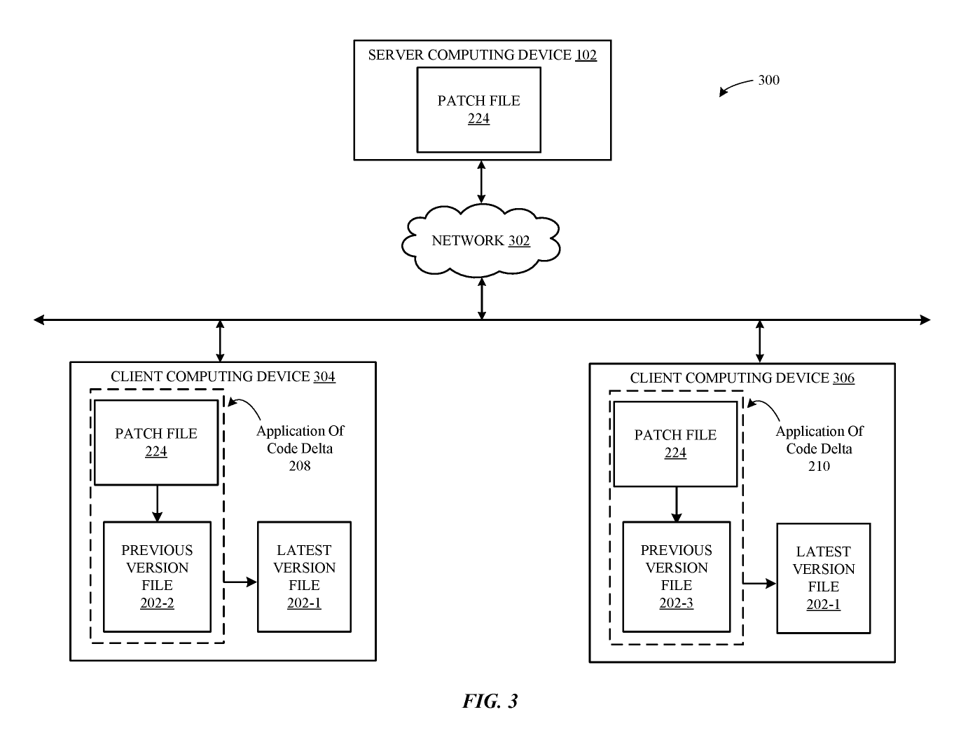

According to some embodiments, the update package generation module 114 includes the functionality to generate one or more patch files using resultant data produced by the delta file generation module 112. For instance, as will be described in greater detail in FIG. 2E, the update package generation module 114 can generate a patch file that includes, among other things, at least two or more code deltas produced by the delta file generation module 112 and their corresponding instruction groups. As will be described in greater detail in FIG. 3, a patch file produced by the update package generation module 114 can be used by several different client computing devices, encompassing a number of different hardware/software profiles. In some scenarios, a patch file produced by the update package generation module 114 can include code deltas that were retrieved from local cache memory by the cache delta file manager 116, which will now be discussed.

As will be described in greater detail in FIG. 4, according to some embodiments, the cache delta file manager 116 includes the functionality to both store and retrieve code deltas, produced by the delta file generation module 112, from cache memory associated with the server computing device 102. According to some embodiments, the cache memory described herein, can be located in the volatile memory 106, the non-volatile memory 118, or a memory storage device (not depicted) that is coupled to the server computing device 102. As will be described in greater detail in FIG. 4, the cache delta file manager 116 and the delta calculation engine 110 can engage in communications to determine if a code delta has already been calculated between a latest version of a file and a previous version of the same file. The availability of code deltas, previously calculated and stored in the local cache memory, enables the server computing device 102 to bypass performing time consuming code delta calculations repeatedly, thereby enabling the server computing device 102 to streamline the manner in which a patch file is created for a particular file. In turn, and as will be described in greater detail in FIG. 3, several different client computing devices can be enabled to receive the same patch file created by the server computing device 102 in a much more efficient manner so that each client computing device can be quickly install the latest version of a file.

Accordingly, FIG. 1 provides a high-level overview of different hardware/software architectures that can be implemented by the server computing device 102 in order to carry out the various techniques described herein. A more detailed breakdown of these techniques will now be provided below in conjunction with FIGS. 2A-2E, 3, 4A-4E, 5, 6, 7A-7B, and 8.

FIGS. 2A-2E illustrate exemplary procedures that are used to generate a multi-version patch file for distribution to different client computing devices, according to some embodiments. For instance, FIG. 2A illustrates an exemplary code delta identification process 200 that can be used to create a multi-version patch file, according to some embodiments. A file 202 is associated with an application that is (1) installed at one or more client computing devices and (2) capable of using an updated version of the file 202, via a file update received from the server computing device 102, whenever the file 202 is modified. In some scenarios, the file 202 can be modified in response to a defect detected in the file 202 or a desire to improve the functionality of the file 202. In such scenarios, the modification of the file 202 can be detected as a result of a system-level file image comparison process in which (1) one or more files associated with one system-level image are compared against (2) one or more files associated with different system-level image. It should be appreciated that the term “file image” or “image,” as used in this instance, is not intended to be limiting and can include any data that represents a snapshot of a file system, utilized by the server computing device 102, that is captured at any given time. It should also be appreciated that the server computing device 102 can use any type of file system which includes, but is not limited to, a local file system, a remote file system, a cloud-based file system, and so on.

In this fashion, several different system-level file image comparisons can be performed in which the circumstances concerning the degree in which the file 202 has been modified can be ascertained. The results of the system-level file image comparison can yield results that include, for example, (1) one or more files that were unmodified for the application, (2) one or more files that were deleted or removed for the application, (3) one or more files that were added for the application, and (4) one or more files that were modified for the application, including modifications made to the file 202. Accordingly, the code delta identification process 200 illustrated in FIG. 2A is performed in response to a detected modification of the file 202 which produces at least three different versions of the file 202: a latest version file 202-1, a previous version file 202-2, and a previous version file 202-3.

The latest version file 202-1 includes, for instance, program code that updates the program code included in the previous version file 202-1. In other words, the previous version file 202-2 includes program code that appeared within the file 202 prior to the modification of the file 202. For instance, in one scenario, the file 202 can be used by the application to specifically perform administrator-level functions for the application. In accordance with this scenario, a programmatic function (i.e., function expressed in application program code) can be designed to produce a menu object that enables an application administrator to allow one particular set of users to view a certain item displayed within a main graphical user interface (“GUI”) for the application. In this described scenario, the difference in the program code between the latest version file 202-1 and the previous version file 202-2 can be that the file versions define two completely different groups of users that are allowed to see the item displayed within the main (“GUI”) of the application. For illustrative purposes, this difference in program code can be depicted by the file representation maps illustrated in FIG. 2A for the latest version file 202-1 and the previous version file 202-2, which will now be discussed.

It should be appreciated that a computing device, receiving a multi-version patch file produced by the described embodiments, includes a local installation partition where the multi-version patch file is installed. This installation partition includes an installed version of file 202, such the previous version files 202-2 and 202-3. Additionally, the installation partition includes a set of one or more data blocks, such as the data blocks 0-7 depicted in FIG. 2A, which store at least a portion of data associated with the file 202. For instance, as illustrated by the file representation map associated with the latest version file 202-1 in FIG. 2A, the latest version file 202-1 includes data segments 204-1, 204-2, and 204-3 which each correspond to a least a portion of the program code associated with the aforementioned programmatic function.

As depicted by the file representation map of the latest version file 202-1, the data segments 204-1, 204-2, and 204-3 can each be installed within a set of one or more data blocks that include the data blocks 1-7. With reference now to the file representation map of the previous version file 202-2, it should be noted that, of the same data segments 204-1, 204-2, and 204-3 currently installed within the data blocks 1-7 of a client computing device (not depicted), the data segment 204-3 includes fewer bits (thus smaller in size) than a counterpart data segment 204-3 associated with the latest version file 202-1. In this manner, the disparity between the data segments 204-3 of the latest version file 202-1 and the previous version file 202-2 can be attributed to the previously discussed differences in program code associated with the aforementioned programmatic function.

As further depicted by the code delta identification process 200, the delta calculation engine 110 identifies the differences in the program code between the latest version file 202-1 and the previous version file 202-3. In some scenarios, the previous version file 202-3 can be another previous version of the file 202 that is installed within the data blocks 1-7 of a different client computing device (i.e., a client computing device that has the previous version file 202-3 installed rather than the previous version file 202-2). In this fashion, the previous version file 202-3 differs from the previous version file 202-2 and the latest version file 202-1 in at least one aspect.

For instance, in the scenario described above, the difference in the program code between the previous version file 202-3 and (1) the previous version file 202-2 and (2) the latest version file 202-1 is that the aforementioned programmatic function in the previous version file 202-3 defines a different group of users than the group defined for (1) the previous version file 202-2 and (2) the latest version file 202-1. With reference now to the file representation map of the previous version file 202-3, it should be noted that the data segment 204-3 is not installed by any client computing device currently using the previous version file 202-3. In this manner, the disparity between the data segments of the previous version file 202-2, the previous version file 202-3, and the latest version file 202-1 can be attributed to the previously discussed program code differences between the previous version file 202-3 and (1) the previous version file 202-2 and (2) the latest version file 202-1.

After the delta calculation engine 110 finishes identifying the differences in the files, the delta file generation module 112 can determine how the program code included in the previous versions of the file 202 described in FIG. 2A can each be updated to enable a client computing device to operate in a manner consistent with a client computing device that has a local installation of the latest version file 202-1. For example, FIG. 2B illustrates how code deltas can be generated for use in creating a multi-version patch file, according to some embodiments. As depicted by the code delta generation procedures 206 illustrated in FIG. 2B, the delta file generation module 112 can use resultant data produced from the identifications made by the delta calculation engine 110 in FIG. 2A to produce code deltas 208 and 210.

For example, based on the identified differences between the latest version file 202-1 and the previous version file 202-2 determined during the code delta identification process 200, the delta file generation module 112 produces the code delta 208. In some scenarios, the code delta 208 includes a respective set of program code that specifies that a first number of bytes can be added to a second number of bytes from the previous version 202-2 to produce the latest version file 202-1. Additionally, based on the identified differences between the latest version file 202-1 and the previous version file 202-3 determined during the code delta identification process 200, the delta file generation module 112 also produces the code delta 210. In some scenarios, the code delta 210 includes a respective set of program code that specify that a first number of bytes can be added to a second number of bytes from the previous version 202-3 to produce the latest version file 202-1. In this fashion, the program code included in either the code delta 208 and the code delta 210 enables a client computing device to find exact or approximate matches against a previous version of the file 202 installed locally (i.e., either the previous version file 202-2 or the previous version file 202-3) and update the local version of the file 202 to the latest version file 202-1, without the need to install any additional/intermediate files or code deltas.

Additionally, during the generation of the code deltas 208 and 210, the delta file generation module 112 can also generate a set of one or more instructions that can be processed by a client computing device, in receipt of a multi-version patch file created by the described embodiments. For instance, FIGS. 2C-2D illustrate how multi-version patch file instructions can be used to update a file locally installed on a client computing device, according to some embodiments. With reference now to the multi-version patch file instruction generation process 212 depicted in FIG. 2C, the delta file generation module 112 generates an instruction group 214 that includes a set instructions that enable a client computing device to upgrade their respective version of the file 202 to the latest version file 202-1, using the contents of a multi-version patch file. For instance, the instruction group 214 includes instructions that direct that a client computing device, with a local installation of the previous version file 202-2, to (1) add a first number of bytes from the previous version file 202-2 to a second number of bytes from the code delta 208, and (2) write the results as output to the local installation partition. Additionally, the instruction group 214 also includes instructions that direct that the client computing device to skip forward a certain number of bytes in the previous version file 202-2 when performing the performing the aforementioned add operation.

Additionally, as depicted in FIG. 2C, the delta file generation module 112 also generates an instruction group 216 that includes a set of instructions that enable a client computing device to upgrade their respective version of the file 202 to the latest version file 202-1. For instance, the instruction group 216 includes instructions that direct that a client computing device, with a local installation of the previous version file 202-3, to (1) add a first number of bytes from the previous version file 202-3 to the same number of bytes from the code delta 210, and (2) write the results as output. Additionally, the instruction group 216 also includes instructions that direct that a computing device to skip forward a certain number of bytes in the previous version file 202-3 when performing the performing the aforementioned add operation.

Notably, the instruction group 216 also includes instructions that direct that the client computing device to copy a certain number of bytes from an archived code section and write them as output, which will be discussed in greater detail in FIG. 2E. It should be appreciated that the instruction groups depicted in FIG. 2C are not meant to be limiting, and can include more or less instruction groups within a given multi-version patch file. Also, it should be appreciated that the instructions depicted in each instruction group depicted in FIG. 2C are not meant to be limiting, and can include more or less instructions. Furthermore, it should be appreciated that the specific instructions depicted in each instruction group depicted in FIG. 2C are not meant to be limiting, and can other types of instructions, such as a “replace” instruction.

According to some embodiments, instruction groups can each be included within a script referenced by a client computing device when performing the file update procedures described herein. For instance, with reference now to a file update script generation process 218 depicted in FIG. 2D, the delta file generation module 112 generates a file update script 220 that includes instructions for the client computing device to, among other things, (1) add one or more files for the application using the file 202, (2) remove one or more files for the application using the file 202, and/or (3) modify one or more files for the application using the file 202, which naturally includes the file 202.

With respect to instructions regarding the modification of the file 202, the file update script 220 also includes instructions that enable the client computing device to select an appropriate instruction group and corresponding code delta (i.e., either code delta 208 or 210) to immediately update any locally installed version of the file 202 to the latest version file 202-1. In this fashion, the file update script 220 enables the client computing device to install the latest version file 202-1 without (1) the need for multiple code deltas or (2) intermediate version files. It should be appreciated that the intermediate version files described herein can refer to other versions of the file 202 that are between the version currently installed on the client computing device and the latest version file 202-1.

For instance, as illustrated in FIG. 2D, the file update script 220 includes the instruction groups 214 and 216 as separate, indexed sections that can be readily referenced by a client computing device when updating a local version of the file 202 to the latest version file 202-1. As will be described in greater detail herein in FIG. 3, the instruction groups 214 and 216 can be quickly referenced by the client computing device when performing a file update. It should be appreciated that the file update script 220 can list the instruction groups described herein in any order. Additionally, it should be appreciated that the file update script 220 depicted in FIG. 2D is not meant to limiting and can be implemented in a variety of different ways. For instance, according to some embodiments, the file update script 220 can implemented as a header file or as metadata that can be referenced by a client computing device when performing the file update procedures described herein.

Turning now to FIG. 2E, FIG. 2E depicts an exemplary multi-patch file, according to some embodiments. As depicted by the multi-patch file generation process 222 illustrated in FIG. 2E, the update package generation module 114 (not depicted) produces a patch file 224 that includes, among other things, the file update script 220 and the code deltas 208 and 210. According to some embodiments, the file update script 220 orchestrates file update procedures performed at a client computing device using the various components included in the patch file 224. Additionally, as illustrated in FIG. 2E, the patch file 224 includes an archived code section 226 that includes new program code to be added to a local installation partition in order to enable a local version of the file 202 to be completely updated to the latest version file 202-1. For instance, the archived code section 226 includes program code that can represent functionality added to the file 202, and included in the latest versions file 202-1. Notably, this functionality includes new code that is unrelated to any program code found in either the previous version file 202-2 or the previous version file 202-3.

It should be appreciated that, although the code deltas included within the patch file 224 are generally packaged together based on small incremental differences between their corresponding file versions, the manner in which code deltas are included with the patch file 224 can be completely arbitrary. For instance, according to some embodiments, a file update policy used by an file update distributor may favor the inclusion of more or less code deltas than those depicted in FIG. 2D. It should also be appreciated that, according to some embodiments, the patch file 224 and/or the contents therein can be delivered to one or more client computing devices using an archive file format that can be extracted by each client computing device. Examples of archive file formats can include, but are not limited to “.zip” file formats, “.tar” file formats, and so on. Also, as will be described in greater detail in FIG. 4E, the patch file 224 also includes a set of one or more error correction codes (“ECC”) 228 that can be used to ensure the integrity of file update installations performed by the described embodiments. As will be described in greater detail in FIG. 4E, ECC 228 can be used to both detect and correct installation errors that occurred when upgrading a local installation of the file 202 to the latest versions file 202-1.

As described herein, multi-version patch files can be distributed among several different client computing devices in which each computing device has a different version of a particular file installed locally. As a result, according to some embodiments, the file update script 220 executes an initial survey (or “digest”) of a client computing device to determine which version of a particular file is installed, prior to the performance of the file update procedures described herein. Upon completion of the file update procedures, the file update script 220 executes a subsequent survey of the computing device to verify that the file has been updated.

For instance, FIG. 3 illustrates how a multi-version patch file, generated by the server computing device 102, can be distributed among several different client computing devices, according to some embodiments. As illustrated by the patch file distribution process 300 depicted in FIG. 3, the client computing devices 304 and 306 each have a previous version of the file 202 installed locally. For instance, the client computing device 304 has the previous version file 202-2 installed locally and the client computing device 306 has the previous version file 202-3 installed locally. Notably, as illustrated in FIG. 3, the client computing devices 304 and 306 each receive the same patch file 224, from the server computing device 102 over a data communications network 302, that includes the contents previously described in FIG. 2E. In this fashion, the file update script 220 is executed, separately, on the client computing devices 304 and 306.

As previously described herein, the file update script 220 surveys a given client computing device to determine which version of the file 202 is currently installed locally. For instance, in the embodiment depicted in FIG. 3, the file update script 220, in addition to the instruction groups 214 and 216, also includes one or more hash values that are used to determine which version of the file 202 is already installed on a client computing device, prior to the performance of the file update procedures described herein. The one or more hash values each correspond to a respective version of the file 202 that is available for installation. In the scenario depicted in FIG. 3, the previous version files 202-2 and 202-3, and the latest version file 202-1 can represent all versions of the file 202 that are available for a client computing device to install locally.

Accordingly, upon execution, each of the file update scripts 220 (1) applies a hash function to a local file 202 installation at the client computing devices 304 and 306, respectively, and (2) based on the computed hash value, determines if a code delta from the patch files 224 needs to be installed for the client computing device to use the latest version file 202-1. For example, if a client computing device already uses the latest version file 202-1, then the computed hash value will indicate a value that corresponds to the latest version file 202-1. In such instances, the described embodiments do not perform any of the file update procedures described herein. However, if the computed hash value indicates a value associated with either the previous version files 202-2 or 202-3, then file update script 220 initiates the file update procedures described herein to update the previous version of the file 202 to the latest version file 202-1.

For instance, with reference to the client computing device 304 depicted in FIG. 3, the file update script 220 computes a hash value using the previous version file 202-2 that is installed locally and determines that the value corresponds to a value associated with the previous version file 202-2. In turn, the file update script 220 directs the client computing device 304 to process the instructions specified in the instruction group 214. In accordance with the instruction group 214, the client computing device 304 combines the code delta 208, included in the patch file 224, with the previous version file 202-2, which ultimately results in the latest version file 202-1 being installed locally at the client computing device 304. For example, with reference to the file representation maps previously illustrated in FIG. 2A, the data segment 204-3, associated with both the previous version file 202-2 and the latest version file 202-1, are not identical. Accordingly, the processing of the instructions specified in the instruction group 214 results in the data segment 204-3 being added to N bytes from the code delta 208 to ultimately produce the latest version file 202-1 locally on the client computing device 304. Upon completion of the file update procedures, the file update script 220 executes a subsequent survey of the client computing device 304 to verify that the file 202 has been updated.

With reference now to the client computing device 306 depicted in FIG. 3, the file update script 220, executed on the client computing device 306, computes a hash value using the previous version file 202-3 that is installed locally and determines that the value corresponds to a value associated with the previous version file 202-3. In turn, the file update script 220 directs the client computing device 306 to process the instructions specified in the instruction group 216. In accordance with the instruction group 216, the client computing device 306 combines the code delta 210, included in the patch file 224, with the previous version file 202-3, which ultimately results in the latest version file 202-1 being installed locally on the client computing device 306 as well.

For instance, with reference again to the file representation maps previously illustrated in FIG. 2A, the data segment 204-2 associated with both the previous version file 202-3 and the latest version file 202-1 are not identical. Additionally, in contrast to the latest version file 202-1, the previous version file 202-3 does not include the data segment 204-3. In this fashion, the client computing device proceeds with instructions specified in the instruction group 216 which results in (1) the data segment 204-2 being added to the same number of bytes from the code delta 210, and (2) N bytes being copied from the archived code section 226 and written to output. After processing these instructions, the latest version file 202-1 is then installed locally on the client computing device 306. Upon completion of the file update procedures, the file update script 220 executes a subsequent survey of the client computing device 306 to verify that the file 202 has been updated.

Accordingly, as demonstrated by the scenario depicted in FIG. 3, a client computing device can install the latest version file 202-1 by using only necessary data that is included in (1) either the code delta 208 or the code delta 210 and/or (2) the archived code section 226. Notably, the compressed nature of the code deltas 208 and 210 enable the client computing device to quickly and efficiently receive the patch file 224, from the server computing device 102 over the data communications network 302. In some scenarios, an update to the application using the file 202 can required a large number of files from the archived code section 226 to be utilized. However, in these scenarios, the code deltas 208 and 210 will correspondingly be even smaller in size (i.e., containing fewer bits to produce the latest version file 202-1) given that fact that fewer changes are made to the file 202. In this fashion, the patch file 224 can be much easier to compress thereby allowing client computing devices to update their respective versions of the file 202 in an even shorter period of time compared to conventional file update solutions.

It should be appreciated that the hash values described herein can include any values generated through a cryptographic hash function. Examples of cryptographic hash function can include, but are not limited to, secure hash algorithms (“SHA”), digital signature algorithms (“DSA”), and so on.

Furthermore, as described herein, the described embodiments can increase the chances of successfully installing a patch file on a client computing device by both (1) minimizing the occurrence of patch file installation errors and (2) performing actions that can remedy a potentially unstable build of a latest version of the file in the event that an interruption occurs during a patch file installation. For instance, FIGS. 4A-4E illustrate how a multi-version patch file generated by a server computing device can be used to reduce the chances of a patch file installation failure occurring on a client computing device, according to some embodiments. Provided a client computing device has sufficient storage space, the client computing device performs actions that result in the generation of a copy of a previous version of a file already installed at the client computing device. As will be readily apparent in FIGS. 4A-4E, this copy can be used for purposes of successfully installing a latest version of the same file.

For instance, with reference to the patch file installation procedures 400 depicted in FIG. 4A, when executing the patch file 224 from a volatile memory 402, the client computing device 304 processes instructions, included in the file update script 220, that cause the client computing device 304 to generate a copy of the previous version file 202-2 (e.g., previous version file copy 408) located in a file location 406. In some scenarios, the previous version file copy 408 can be generated within the file location 406 or a different file location at the client computing device 304. Notably, the client computing device 304 produces the previous version file copy 408 prior to performing any of the patch file installation procedures described herein that involve the use of the previous version file 202-2. According to some embodiments, the previous version file 202-2 can be renamed to produce a “copy” (i.e., the previous version file copy 408) of the previous version file 202-2. By instructing the client computing device 304 to produce the previous version file copy 408 in the manner described herein, the patch file 224 enables the client computing device 304 to successfully complete the patch file installation procedures described herein, even in the event that the patch file installation process is interrupted.

For example, FIG. 4B depicts patch file “out-of-place” installation procedures 410 that can be performed on client computing devices that utilize an “out-of-place” file-write system. Notably, the embodiment depicted in FIG. 4B also depicts a scenario in which a patch file installation process, at some point, is interrupted. As a result of the interruption, and as illustrated in FIG. 4B, the previous version file 202-2 becomes unavailable for use in the patch file installation process (depicted as an “X” over the previous version file 202-2). In response to this interruption, the previous version file copy 408 is loaded into the volatile memory 402, where the client computing device 304 processes instructions specified in the patch file 224 to produce the latest version file 202-1.

For instance, continuing with the patch file “out-of-place” installation procedures 410 described now in FIG. 4C, the client computing device 304 processes instructions in the file update script 220 (e.g., the instruction group 214 previously described in FIG. 3) to build the latest version file 202-1 based, at least in part, on the contents of the previous version file copy 408 and the code delta 208 included in the patch file 224 (not depicted in FIG. 4C). In turn, the latest version file 202-1 can be placed in the original file location 406 or in a different file location. Accordingly, the client computing device 304 processes instructions included in the file update script 220 that cause the client computing device 304 to restart the patch file installation process using the previous version file copy 408 after a detected interruption. Furthermore, provided installation of the latest version file 202-1 is successful, the client computing device 304 also processes instructions specified in the file update script 220 to delete the previous version file copy 408 (depicted as an “X” over the previous version file copy 408), thereby increasing the amount of memory space on the client computing device 304 after completion of the patch file installation process.

Also, as described herein, the patch file 224 enables client computing devices that utilize an “in-place” file-write system to successfully complete the patch file installation procedures described herein, even in the event that the patch file installation process is interrupted. For instance, FIG. 4D depicts patch file “in-place” installation procedures 412 that can be performed on client computing devices that utilize an “in-place” file-write system, according to some embodiments. In such systems, and prior to an interruption, the client computing device 304 modifies the previous version file 202-2 (not depicted in FIG. 4D) in the non-volatile memory 404 using a sequence of read/write operations to build the latest version file 202-1 based on the contents included in the patch file 224 (e.g., the code delta 208). However, in accordance with the scenario depicted in FIG. 4D, the patch file installation process can be interrupted.

After detecting the interruption, the client computing device 304 processes instructions included in the file update script 220 to calculate a hash value for use, by the file update script 220, in determining whether the previous version file 202-2 is currently in a “valid” or “invalid” state after the interruption. According to some embodiments, the hash value can be based, at least in part, on memory state data 414 stored in the non-volatile memory 404. In this fashion, the memory state data 414 assists the file update script 220 in identifying the current state of the previous version file 202-2 after an interruption occurs during the patch file installation process. A valid state determination, made by the file update script 220, can indicate that the previous version file 202-2 was successfully updated to the latest version file 202-1. An invalid state determination, on the other hand, can indicate that the previous version file 202-2 was not successfully updated to the latest version file 202-1.

For example, as depicted in FIG. 4D, based on a hash value calculation performed at the client computing device 304 (using the memory state data 414 stored at the client computing device 304), the file update script 220 determined that the previous version file 202-2 is currently in an invalid state. In turn, the client computing device 304 then processes instructions included in the file update script 220 that cause the client computing device 304 to restart the patch file installation process using the previous version file copy 408. According to some embodiments, the file update script 220 can use the data provided by the memory state data 414 to enable the client computing device 304 to resume the patch file installation process from a point just prior to the occurrence of the interruption, rather than restarting the patch file installation process. In such scenarios, the file update script 220 can include instructions that specify, to the client computing device 304, which portions of the patch file 224 should be used in order to build the latest version file 202-1 based on various potential states of the previous version file 202-2.

Accordingly, using the procedures described in FIG. 4D, the client computing device 304 can use the previous version file copy 408 to build the latest version file 202-1, instead of resuming the patch file installation process based on potentially corrupted/unstable data included in the previous version file 202-2 to produce the same file. Although not explicitly depicted in FIG. 4D, provided the installation of the latest version file 202-1 is successful, the client computing device 304 also processes instructions specified in the file update script 220 to delete the previous version file copy 408, thereby increasing the amount of memory space on the client computing device 304 after completion of the patch file installation process.

Notably, according to some embodiments, the file update script 220 can also track the number of interruptions that occur during a particular patch file installation process (e.g., using a counter). Thus, in the event that additional interruptions occur during the process of installing the latest version file 202-1 at the client computing device 304, the file update script 220 can perform additional measures to ensure that a stable version of the latest version file 202-1 is successfully installed. For instance, after a second interruption is detected at the client computing device 304 (i.e., a second interruption that occurs after the interruption discussed in FIGS. 4B-4D), the file update script 220 executes a survey or “digest” of the client computing device 304 to determine if any errors were detected during installation of the latest version file 202-1. According to some embodiments, the survey can include the use of one or more error detection schemes that include, but are not limited to, cyclic redundancy checks (“CRCs”), checksums, parity bits, and the like.

According to some embodiments, the survey detects errors by determining whether any data bits/blocks were flipped either prior to or during the patch file installation process. The flipping of data bits/blocks in this manner can result in an unsuccessful/corrupted installation of the latest version file 202-1. When attempting to determine whether any data bits/blocks were flipped, the survey locates one or more parity bits that were installed during the patch file installation process. For instance, the survey locates a parity bit added to the code delta 208, the archived code section 226, or a different item included in the patch file 224. According to some embodiments, the value of the parity bit can be determined prior to the transmission of the patch file 224 to the client computing device 304. In this manner, after locating the parity bit, the parity bit is re-calculated and compared to a previously determined parity bit value. Provided the values are equal, the file update script 220 can determine that the installation of the latest version file 202-1 was successfully completed without further action. However, if the values are determined to be not equal, then the file update script 220 determines that at least one error occurred during the installation of the latest version file 202-1. In turn, the file update script 220 corrects detected errors using one or more ECCs included in the patch file 224.

For example, the error correction code application procedures 416 depicted in FIG. 4E capture a scenario in which a survey identified that at least one error was detected during the installation of the latest version file 202-1 at the client computing device 304, according to some embodiments. In response to the detection of an error, and as illustrated in FIG. 4E, the client computing device 304 processes instructions, specified by the file update script 220, to use one or more ECCs 228 that are included within the patch file 224. Examples of ECCs included in the ECCs 228 can include, but are not limited to, Reed-Solomon codes, Hamming codes, low density parity check (“LDPC”) codes, and the like. In addition to the one or more ECCs 228, the file update script 220 also reads a current version of the file 202 that is presently in the non-volatile memory 404 (i.e., the current version file 418). Notably, in the scenario depicted in FIG. 4E, the current version file 418 is known to be invalid prior to the performance of the error correction code application procedures 416 illustrated in FIG. 4E. In some scenarios, the current version file 418 can be deemed invalid after one or more attempts to install a stable version of the latest version file 202-1 are unsuccessful. Accordingly, as depicted in FIG. 4E, the file update script 220 uses one or more ECCs 228 to correct any identified differences between the current version file 418 and a stable version of the latest version file 202-1 to produce the latest version file 202-1. As a result of performing the error correction code application procedures 416, the file update script 220 completes a successful installation of the latest version file 202-1 at the client computing device 304 without any errors. However, in the event that latest version file 202-1 is still installed at the client computing device 304 with a detected error, according to some embodiments, the client computing device 304 processes instructions included in the file update script 220 that cause the client computing device 304 to report a failure to the client computing device 304 and/or engage the client computing device 304 in troubleshooting procedures to correct the errors.

It should be appreciated that the number of ECCs 228 included in the patch file 224 can be arbitrary. For instance, in one scenario, the number of ECCs 228 included in the patch file 224 can be based patch file size considerations. For instance, a fewer number of ECCs 228 can be included in the patch file 224 in order enable efficient transmission of the patch file 224 to one or more client computing devices. In another scenario, a larger number of ECCs 228 can be included in the patch file 224 in order enable more efficient detection and correction of errors during the installation of the latest version file 202-1 at a particular client computing device. It should also be appreciated that the procedures depicted in FIGS. 4A-4E can be performed using other client computing devices, including the client computing device 306 described herein.

Notably, the use of (1) the previous version file copy 408 and (2) ECCs 228, as described in FIGS. 4A-4E, also enables the described embodiments to apply heuristics when handling interruptions that occur during the performance of the patch file installation procedures described herein. For instance, the instructions included in the file update script 220 can specify that, after a first interruption, the client computing device 304 should use the previous version file copy 408 instead of the previous version file 202-2 in a manner consistent with FIGS. 4A-4D. The instructions included in the file update script 220 can also specify that, after a second interruption, the client computing device 304 should perform the error detection/correction procedures described in FIG. 4E to further increase the likelihood of a successful installation of the latest version file 202-1. In some scenarios, the file update script 220 can specify that, after a first interruption, the client computing device 304 should first perform the error detection/correction procedures described in FIG. 4E and then subsequently perform the procedures detailed in FIGS. 4A-4D involving the use of the previous version file copy 408 after a second interruption. It should be appreciated that the described embodiments are not limited to the heuristics described herein and can include a number of different approaches that can ensure the successful installation of the latest version file 202-1.

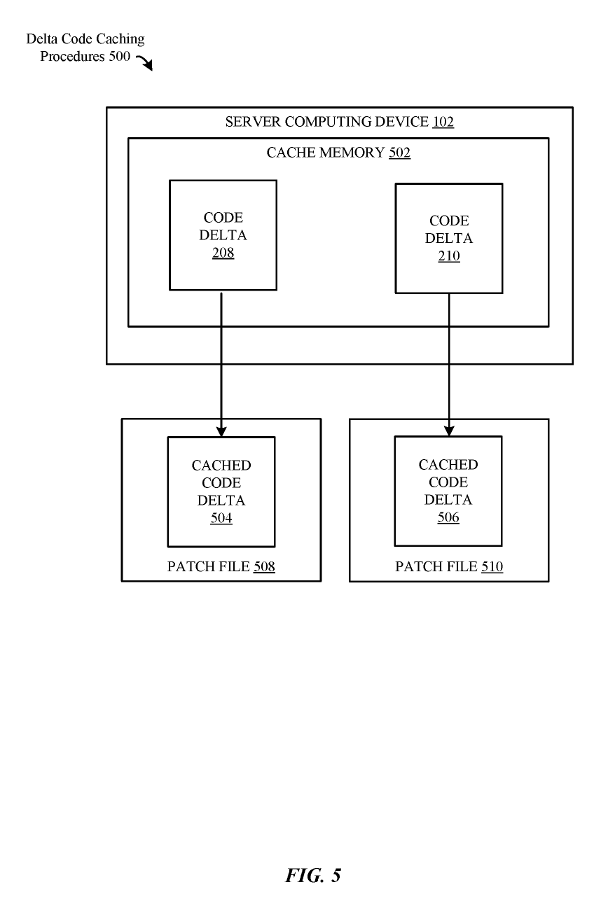

Furthermore, as described herein, the server computing device 102 can also include cache memory that enables the server computing device 102 to increase the speed at which the patch file 224 is distributed to different client computing devices, such as the client computing devices 304 and 306. For instance, FIG. 5 illustrates exemplary delta code caching procedures 500 performed during the creation of a multi-version patch file, according to some embodiments. Upon completion of the described code delta calculation procedures, the cache delta file manager 116 stores each code delta at the server computing device 102. As illustrated in FIG. 5, the cache delta file manager 116 stores the code deltas 208 and 210 in a cache memory 502 in a manner that enables each code delta to be quickly retrieved by the update package generation module 114 in order to quickly produce a new patch file.

For instance, in the scenario depicted in FIG. 5, the code deltas 208 and 210 can be created prior to the delta calculation engine 110 performs the procedures described in FIGS. 2A-2D. In accordance with this scenario, the delta calculation engine 110 initially queries the cache delta file manager 116 to determine if a code delta has already been calculated between the latest version file 202-1 and each of (1) the previous version file 202-2, and (3) the previous version file 202-3. In turn, the cache delta file manager 116 scans the contents of the cache memory 502 and notifies the delta calculation engine 110 of the availability of the code deltas 208 and 210. Upon receipt of this notification, the delta calculation engine 110 bypasses the performance of the code delta calculation procedures described in FIGS. 2A-2D in favor of identifying versions of the file 202 that have yet to be associated with a code delta (i.e., prior versions of the file 202 other than the previous version files 202-2 and 202-3). Accordingly, as depicted in FIG. 5, cached versions of the code deltas 208 and 210, such as cached code deltas 504 and 506, can be included in subsequent patch files, such as the patch files 508 and 510. It should be appreciated that, although the cached code deltas 504 and 506 are depicted in FIG. 5 as being included in separate patch files, the described embodiments are not limited in this respect and can configured to include the cached code deltas 504 and 506 in a same patch file, such as the patch file 224.

Indeed, the storage of the code deltas 208 and 210 in the cache memory 502 completely avoids the need to re-calculate code differences between the latest version file 202-1 and each of (1) the previous version file 202-2, and (3) the previous version file 202-3 since these differences are already included by the code deltas 208 and 210. Additionally, the storage of the code deltas 208 and 210 in the cache memory 502 also enables the server computing device 102 to re-distribute the code deltas 208 and 210 to different types of client computing devices. For instance, in one scenario, a mail application, such as Apple Inc.'s Apple Mail® can be executed via a smartphone, such as Apple Inc.'s iPhone®. The same mail application can also be executed by a different type of computing device, such as Apple Inc.'s iPad® tablet computing device. In this fashion, the mail application, despite being executed in different computing environments, can still use the same file, such as the file 202, which requires an occasional file update. Accordingly, the code deltas 208 and 210 stored in the cache memory 502 can be readily accessed and quickly included in any given patch file that is communicated to both the desktop computing device and the tablet computing device for updating their respective files 202. In this fashion, the need to re-calculate code deltas for different types of computing devices is also avoided by the described embodiments.

It should be appreciated that client computing devices are not limited to just desktop computing devices and tablet computing devices and can include other types of computing devices that include, but are not limited to, wireless hand-held devices (e.g., mobile phone, pager, and so on), wireless wearable devices capable of wirelessly transmitting digital information (e.g., electronic watch devices), and so on. It should also be appreciated that, according to some embodiments, rather than querying the cache delta file manager 116 to determine if a code delta has already been calculated for a particular file version, the delta calculation engine 110 can instead query the cache delta file manager 116 to determine if a particular patch file has been cached in memory resident on the server computing device 102. In this fashion, the delta calculation engine 110 can implicitly determine whether a particular set of code deltas are stored in the cache memory, rather than performing queries at a per-code delta level.

Using the file update procedures described herein, a server computing device can efficiently push file updates to several different computing devices in a much more streamlined manner compared to conventional solutions. The file update procedures described herein reduce the need to use several different computing machines when generating a file update for several different types of client computing devices. As illustrated by the various embodiments described herein, the benefits of the described embodiments are not only realized by a server computing device, but also by each client computing device that as an application in need of a particular file update. Indeed, developers and/or distributors of a particular application can use the described embodiments to both minimize computational resource costs while also quickly and efficiently deliver patch files to a variety of different client computing devices so that users of the application can use an up-to-date version of the application that includes minimal defects.

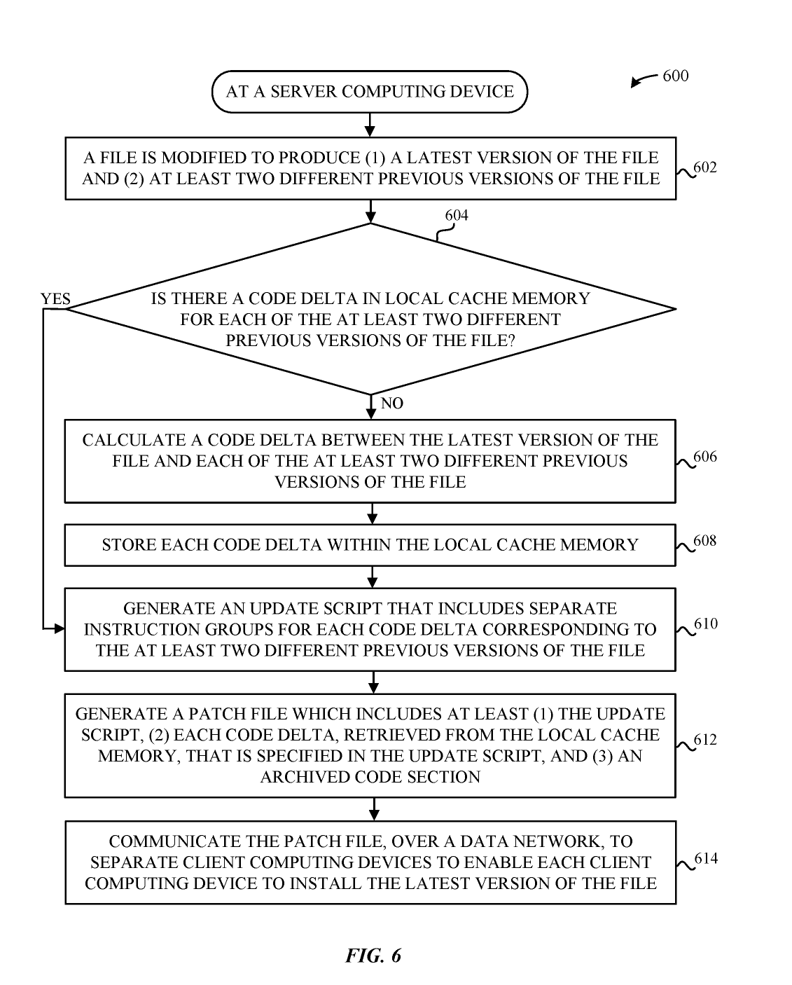

FIG. 6 illustrates a method 600 for generating a multi-version patch file at a server computing device, according to some embodiments. As shown in FIG. 6, the method 600 can be implemented by a server computing device (e.g., the server computing device 102) or other software, hardware, or combination thereof. The method 600 begins at step 602, where a file is modified to produce (1) a latest version of the file and (2) at least two different previous versions of the file. Next, at step 604, a cache delta file manager is queried to determine if there is a code delta, stored in local cache memory, that is already calculated for each of the at least two different previous versions of the file. If the local cache memory includes a code delta that is already calculated for each of the at least two different previous versions, then a delta file generation module generates an update script that includes separate instruction groups for each code delta corresponding to the at least two different previous versions of the file, as detailed at step 610. Otherwise, a delta calculation engine calculates a code delta between the latest version of the file and each of the at least two different previous versions of the file, as detailed at step 606. Next, at step 608, the delta file generation module stores each code delta, calculated by the delta calculation engine, within the local cache memory. Next, at step 612, an update package generation module generates a patch file which includes at least (1) the update script, (2) each code delta, retrieved from the local cache memory, that is specified in the update script, and (3) an archived code section. Finally, at step 614, the server computing device communicates the patch file, over a data network, to separate client computing devices to enable each client computing device to install the latest version of the file.

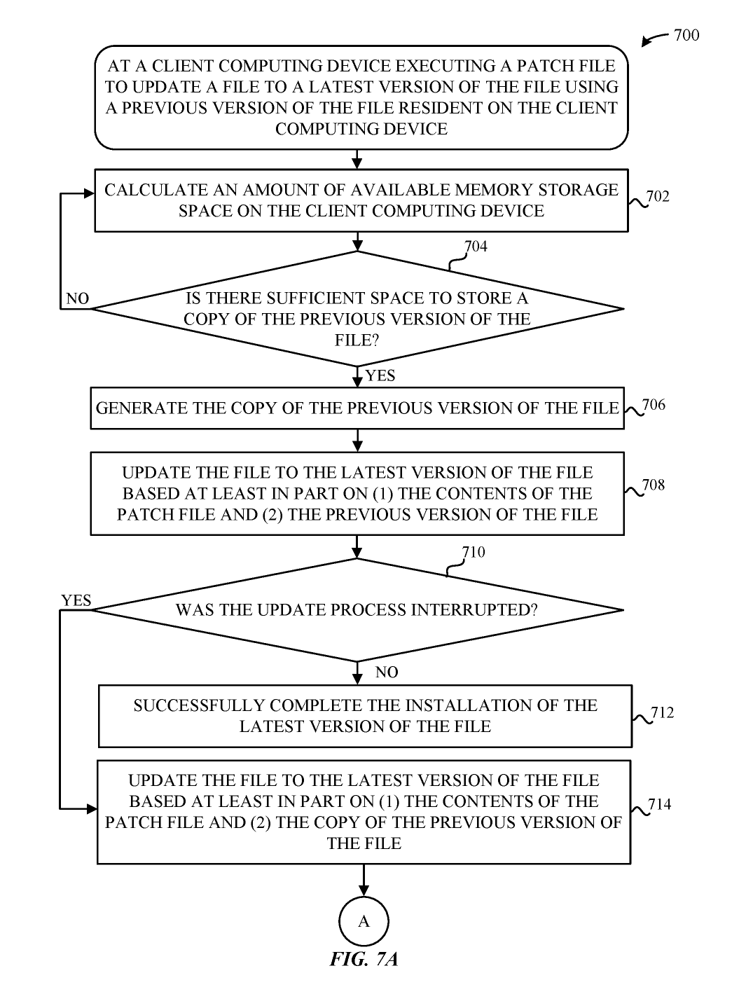

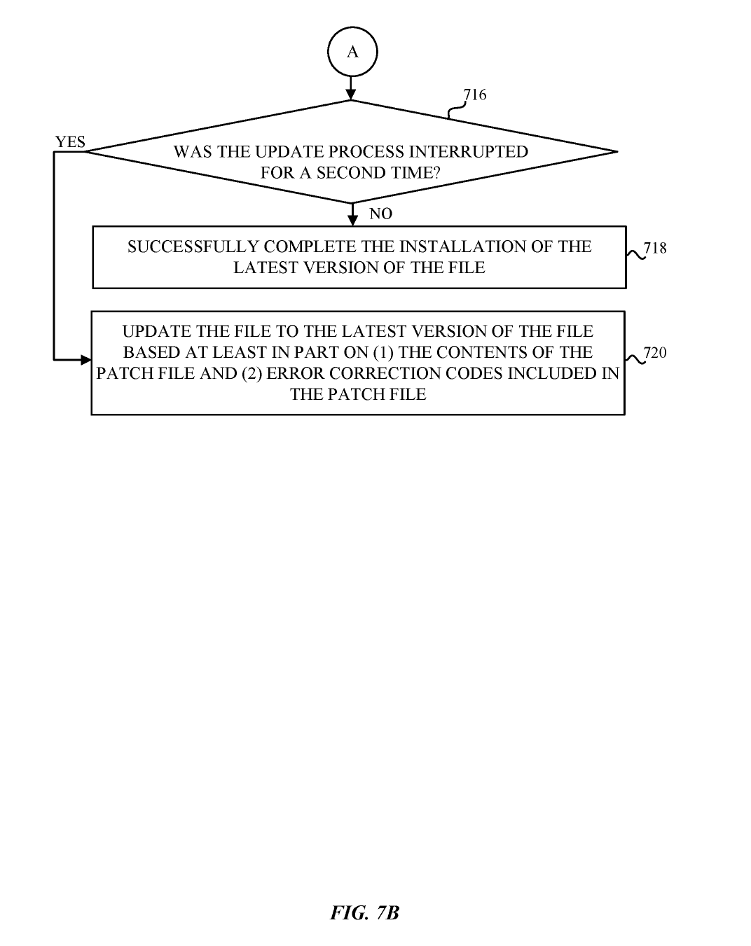

FIGS. 7A-7B illustrate a method 700 for reducing the chances of a patch file installation failure occurring on a client computing device, according to some embodiments. As shown in FIG. 7A, the method 700 can be implemented by a client computing device (e.g., the client computing devices 304, 306) or other software, hardware, or combination thereof. Also, as shown in FIG. 7A, the client computing device executes a patch file to update a file to a latest version of the file using a previous version of the file resident on the client computing device. The method 700 begins at step 702, where the client computing device calculates an amount of available memory storage space on the client computing device. Next, at step 704, the client computing device determines whether the calculated amount of available memory storage space is sufficient to store a copy of the previous version of the file. If the calculated amount is sufficient, then the client computing device generates the copy of the previous version of the file, as detailed at step 706. Otherwise, the client computing device continues to calculate an amount of available memory storage space on the client computing device, as detailed at step 702.

Next, at step 708, the client computing device updates the file to the latest version of the file based at least in part on (1) the contents of the patch file and (2) the previous version of the file. Next, at step 710, the client computing device determines whether the update process was interrupted. If the update process was interrupted, then the client computing device updates the file to the latest version of the file based at least in part on (1) the contents of the patch file and (2) the copy of the previous version of the file, as detailed at step 714. Otherwise, the client computing device successfully completes the installation of the latest version of the file, as detailed at step 712. Next, at step 716 in FIG. 7B, the client computing device determines whether the update process was interrupted for a second time. If the update process was interrupted for a second time, then the client computing device updates the file to the latest version of the file based at least in part on (1) the contents of the patch file and (2) the error correction codes included in the patch file, as detailed at step 720. Otherwise, the client computing device successfully completes the installation of the latest version of the file, as detailed at step 718.

FIG. 8 illustrates a detailed view of a computing device 800 that can be used to implement the various components described herein, according to some embodiments. In particular, the detailed view illustrates various components that can be included the server computing device 102 illustrated in FIG. 1. As shown in FIG. 8, the computing device 800 can include a processor 802 that represents a microprocessor or controller for controlling the overall operation of the computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, and so on. Still further, the computing device 800 can include a display 822 that can be controlled by the processor 802 to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include a wireless transceiver.

As noted above, the computing device 800 also include the storage device 840, which can comprise a single disk or a collection of disks (e.g., hard drives), and includes a storage management module that manages one or more partitions within the storage device 840. In some embodiments, storage device 840 can include flash memory, semiconductor (solid state) memory or the like. The computing device 800 can also include a Random-Access Memory (“RAM”) 820 and a Read-Only Memory (“ROM”) 804. The ROM 804 can store programs, utilities or processes to be executed in a non-volatile manner. The RAM 820 can provide volatile data storage, and stores instructions related to the operation of applications executing on the server computing device 102, including the delta calculation engine 110, the delta file generation module 112, the update package generation module 114, and the cache delta file manager 116.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for generating a multi-version patch file, the method comprising, at a server computing device:
modifying a first file to produce a plurality of versions associated with the first file, wherein the plurality of versions comprises: (i) a latest version associated with the first file, and (ii) at least two previous versions relative to the latest version;
identifying a difference between the latest version and the at least two previous versions to produce first and second delta versions of the first file; and
generating the multi-version patch file for installation by a client computing device, wherein the multi-version patch file (i) comprises the first and second delta versions, and (ii) causes a second file, that corresponds to the first file and stored on the client computing device, to be updated to the latest version using at least one of the first and second delta versions.

2. The method of claim 1, further comprising:
caching the first and second delta versions to produce a first cached delta version and a second cached delta version of the first file, wherein the first cached delta version and the second cached delta version are used to generate a subsequent multi-version patch file.

3. The method of claim 2, wherein the subsequent multi-version patch file (i) comprises the first and second cached delta versions, and (ii) causes different computing environments containing a third file, that corresponds to the first file, to be updated to the latest version.

4. The method of claim 3, wherein the different computing environments are associated with:
a tablet computing device, a mobile phone device, a laptop computing device, and a desktop computing device.

5. The method of claim 1, wherein generating the multi-version patch file further comprises:
generating an update script for inclusion in the multi-version patch file, wherein the update script comprises (1) a first set of instructions for using the first delta version to install the latest version and (2) a second set of instructions for using the second delta version to install the latest version.

6. The method of claim 5, wherein the update script comprises one or more hash values used to determine whether the first set of instructions or the second set of instructions is to be executed at the client computing device.

7. The method of claim 1, wherein the multi-version patch file comprises an archived code section that includes new code not detected in either of the at least two previous versions.

8. A computing device configured to generate a multi-version patch file, the computing device comprising:
at least one processor; and
at least one memory configured to store instructions that, when executed by the at least one processor, cause the computing device to:
modify a first file to produce a plurality of versions associated with the first file, wherein the plurality of versions comprises: (i) a latest version associated with the first file, and (ii) at least two previous versions relative to the latest version;
identify a difference between the latest version and the at least two previous versions to produce first and second delta versions of the first file; and
generate the multi-version patch file for installation by a client computing device, wherein the multi-version patch file (i) comprises the first and second delta versions, and (ii) causes a second file, that corresponds to the first file and stored on the client computing device, to be updated to the latest version using at least one of the first and second delta versions.

9. The computing device as described in claim 8, wherein the at least one processor further causes the computing device to cache the first and second delta versions to produce a first cached delta version and a second cached delta version of the first file, wherein the first cached delta version and the second cached delta version are used to generate a subsequent multi-version patch file.

10. The computing device as described in claim 9, wherein the subsequent multi-version patch file (i) comprises the first and second cached delta versions, and (ii) causes different computing environments containing a third file, that corresponds to the first file, to be updated to the latest version.

11. The computing device as described in claim 10, wherein the different computing environments are associated with:
a tablet computing device, a mobile phone device, a laptop computing device, and a desktop computing device.

12. The computing device as described in claim 8, wherein the at least one processor further causes the computing device to generate an update script for inclusion in the multi-version patch file, wherein the update script comprises (1) a first set of instructions for using the first delta version to install the latest version and (2) a second set of instructions for using the second delta version to install the latest version.

13. The computing device as described in claim 12, wherein the update script comprises one or more hash values used to determine whether the first set of instructions or the second set of instructions is to be executed at the client computing device.

14. The computing device as described in claim 8, wherein the multi-version patch file comprises an archived code section that includes new code not detected in either of the at least two previous versions.

15.-20. (canceled)

21. At least one non-transitory computer readable storage medium configured to store instructions that, when executed by at least one processor included in a computing device, cause the computing device to generate a multi-version patch file, by carrying out steps that include:
modifying a first file to produce a plurality of versions associated with the first file, wherein the plurality of versions comprises: (i) a latest version associated with the first file, and (ii) at least two previous versions relative to the latest version;
identifying a difference between the latest version and the at least two previous versions to produce first and second delta versions of the first file; and
generating the multi-version patch file for installation by a client computing device, wherein the multi-version patch file (i) comprises the first and second delta versions, and (ii) causes a second file, that corresponds to the first file and stored on the client computing device, to be updated to the latest version using at least one of the first and second delta versions.

22. The at least one non-transitory computer readable storage medium of claim 21, wherein the steps further include:
caching the first and second delta versions to produce a first cached delta version and a second cached delta version of the first file, wherein the first cached delta version and the second cached delta version are used to generate a subsequent multi-version patch file.

23. The at least one non-transitory computer readable storage medium of claim 22, wherein the subsequent multi-version patch file (i) comprises the first and second cached delta versions, and (ii) causes different computing environments containing a third file, that corresponds to the first file, to be updated to the latest version.

24. The at least one non-transitory computer readable storage medium of claim 23, wherein the different computing environments are associated with:
a tablet computing device, a mobile phone device, a laptop computing device, and a desktop computing device.

25. The at least one non-transitory computer readable storage medium of claim 21, wherein generating the multi-version patch file further comprises:
generating an update script for inclusion in the multi-version patch file, wherein the update script comprises (1) a first set of instructions for using the first delta version to install the latest version and (2) a second set of instructions for using the second delta version to install the latest version.

26. The at least one non-transitory computer readable storage medium of claim 25, wherein the update script comprises one or more hash values used to determine whether the first set of instructions or the second set of instructions is to be executed at the client computing device.
